(19) United States
(12) Patent Application Publication
(10) Pub. No.: US 2026/0072737 A1
(43) Pub. Date: Mar. 12, 2026

(54) TASK-ORIENTED ARCHITECTURE FOR COMPUTATIONAL APPLICATIONS

(71) Applicant: Samsung Electronics Co., Ltd., Suwon-si (KR)

(72) Inventors: Chunlin WANG, Cupertino, CA (US); Baoguang YANG, San Diego, CA (US); Seunghun JIN, Cupertino, CA (US); Ye HU, San Jose, CA (US)

(21) Appl. No.: 19/094,811

(22) Filed: Mar. 28, 2025

Related U.S. Application Data
(60) Provisional application No. 63/694,133, filed on Sep. 12, 2024.

(51) Int. Cl. G06F 9/48; G06F 9/38; G06F 9/54

(52) U.S. Cl. CPC G06F 9/4893; G06F 9/3867; G06F 9/4887; G06F 9/544

(57) ABSTRACT

A system and a method for implementing an application-specific cluster are disclosed. A first processor has a first architecture for a first functionality and is configured to perform a first sub-task of a task. A second processor has a second architecture for a second functionality and is configured to perform a second sub-task of the task. The second sub-task is different from the first sub-task. A power management circuit is configured to manage power consumption of the first and second processors according to the first and second sub-tasks, respectively. A driver is configured to perform task management for the first and second sub-tasks and control the power management circuit based on the first and the second sub-tasks.

### CROSS-REFERENCE TO RELATED APPLICATION

This application claims the priority benefit under 35 U.S. C. § 119(e) of U.S. Provisional Patent Application Ser. No. 63/694,133 filed on Sep. 12, 2024, the disclosure of which is incorporated by reference in its entirety as if fully set forth herein.

### TECHNICAL FIELD

The disclosure generally relates to computer architecture. More particularly, the subject matter disclosed herein relates to task-oriented architecture.

### BACKGROUND

The present background section is intended to provide context only, and the disclosure of any concept in this section does not constitute an admission that said concept is prior art.

Multiprocessor systems have been popular in computer architecture. A multiprocessor system typically includes multiple processors connected to one another through an interconnection network. The main objectives for multiprocessor systems include fast throughput, fault tolerance, and shared resources. A multiprocessor system may be homogeneous or heterogeneous. In a homogeneous multiprocessor system, all processors are identical, being of the same type. They may or may not execute identical programs. In a heterogeneous multiprocessor system, there are processors that are different, having different architectures and/or instruction sets.

Multiprocessor systems, whether homogenous or heterogeneous, suffer a number of drawbacks. The allocation and/or scheduling of tasks to the processors may not be efficient, resulting in wasted resources and high power consumption. The performance improvement compared to a single processor may not be sufficient to compensate for the increased hardware and power consumption. The management and control of the processors may be too complex.

The above information disclosed in this Background section is only for enhancement of understanding of the background of the disclosure and therefore it may contain information that does not constitute prior art.

### SUMMARY

To overcome these issues, systems and methods are described herein for a technique to provide high processing power with minimal power consumption. The technique allows flexibility, scalability, expandability, fault-tolerance, and efficient use of computing resources including processor usage and memory utilization. The technique employs a system of multiple processors or processing units with different architectures and functionalities. The processors are assigned to operate on tasks that have been selected as part of a processing chain.

In one embodiment, the technique includes at least two processors assigned to work on a task having multiple pipeline stages. An example of such a task is a rendition of graphical objects. A graphic task typically has several sub-tasks that may be formed in a pipeline. A first processor has a first architecture for a first functionality and is configured to perform a first sub-task of a task. A second processor has a second architecture for a second functionality and is configured to perform a second sub-task of the task. The second sub-task is different from the first sub-task. For example, the first sub-task may be vertex shading and the second sub-task may be rasterization. Executing a sub-task consumes power according to the task computational requirements. A power management circuit is configured to manage power consumption of the first and second processors according to the first and second sub-tasks, respectively. Providing power based on the computational requirements of the sub-tasks optimizes power consumption. A driver is configured to perform task management for the first and second sub-tasks and control the power management circuit based on the first and second sub-tasks.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system according to an embodiment.

FIG. 2 is a diagram illustrating an application-specific cluster according to an embodiment.

FIG. 3 is a diagram illustrating a big/little processing unit according to an embodiment.

FIG. 4 is a diagram illustrating a task manager according to an embodiment.

FIG. 5 is a diagram illustrating a pipeline for temporal parallelism according to an embodiment.

FIG. 6 is a diagram illustrating a pipeline for spatial parallelism according to an embodiment.

FIG. 7 is a flowchart illustrating a process for performing a task in a cluster of processing units according to an embodiment.

FIG. 8 is a flowchart illustrating a process for performing a sub-task using a processor in a cluster of processing units according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, the term “solid-state” in the context of storage refers to a storage technology that uses integrated circuits, instead of moving parts (e.g., spinning disks, platters, read/write heads) to store data. The term “flash memory” refers to a type of non-volatile memory which retains data even when power is removed. It is commonly used in solid-state drives (SSDs). There are two types of flash memory: NAND flash and NOR flash. The NAND flash memory has high storage density and lower cost per bit and is suitable for SSDs, mobile applications. The NOR flash is optimized for random access and is often used in applications requiring fast code execution.

As used herein, the term “buffer” in the context of storage refers to a memory device that store data or information on a temporary basis as part of an operation that involves moving data from one location to another. A buffer is typically implemented by static random-access memory (RAM) for fast access. A buffer may be organized as a standard SRAM or a first-in-first-out (FIFO) organization.

As used herein, the term “processor” or “processing unit” refers to a device, circuit, or package that can execute a program or instructions to perform a specified task or function. It typically has access to memory circuits or devices to read instructions or data and to write data. It may also have interfaces to input and output devices.

In an embodiment, a technique to enhance processing time and power consumption of a cluster of processors configured to perform specialized functions such as graphics. A first processor has a first architecture for a first functionality and is configured to perform a first sub-task. A second processor has a second architecture for a second functionality and is configured to perform a second sub-task different from the first sub-task. For example, the first sub-task may be vertex shading and the second sub-task may be rasterization. Executing a sub-task consumes power according to the task computational requirements. A power management circuit is configured to manage power consumption of the first and second processors according to the first and second sub-tasks, respectively. Providing power based on the computational requirements of the sub-tasks optimizes power consumption. A driver is configured to perform task management for the first and second sub-tasks and control the power management circuit based on the first and second sub-tasks. The first and second sub-tasks are parts of a task.

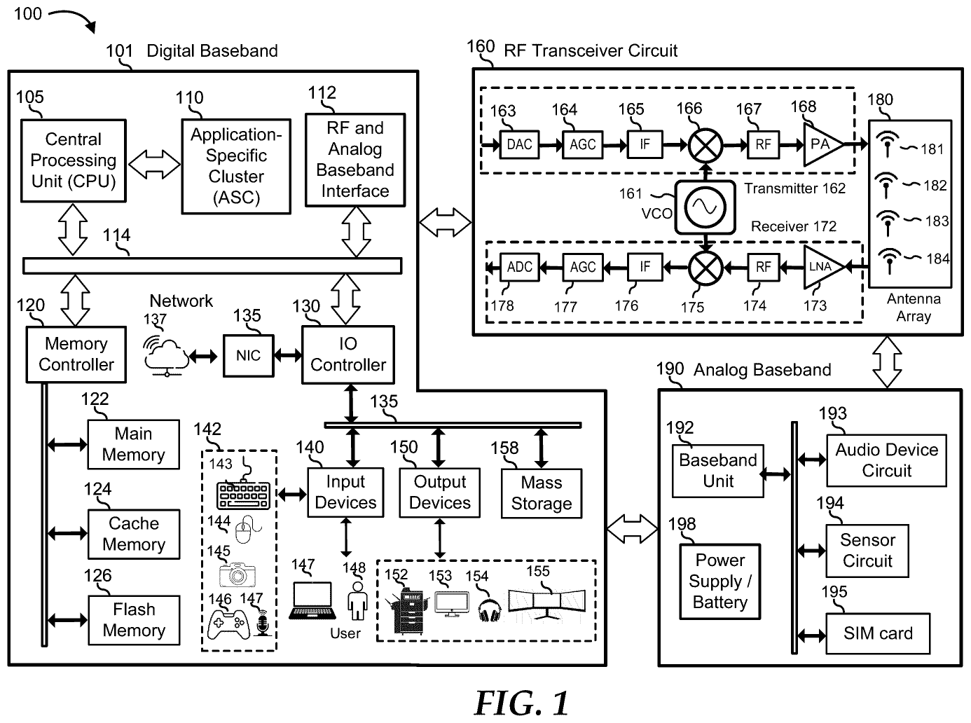

FIG. 1 is a block diagram illustrating a system 100 according to an embodiment. The system 100 includes a digital baseband circuit 101, a radio frequency (RF) transceiver circuit 160, and an analog baseband circuit 190. The system 100 may represent a digital system or a mobile system. When the system 100 is used as a digital system without mobile circuitry, the RF and analog baseband interface 112 (in the digital baseband circuit 101), the RF transceiver circuit 160, and the analog baseband circuit 190 are not used. In addition, when the system 100 is used as a mobile device, many of the digital devices are scaled back and some devices may not be available.

The digital baseband circuit 101 includes central processing unit (CPU) 105, an application-specific cluster (ASC) 110, a radio frequency (RF) and analog baseband interface 112, a memory controller 120, and an IO controller 130. The system 100 may include more or less than the above components. In addition, a component may be integrated into another component. The integration may be partial and/or overlapped. For example, the memory controller 120 and the I/O controller 130 may be integrated into one single controller.

The CPU 105 is a programmable device that may execute a program or a collection of instructions to carry out a task. It may be a host that controls or manages other processors or devices including the ASC 110. In particular, the CPU 105 may include applications programming interfaces (APIs), applications, or drivers that are executed by the CPU 105 to perform specified tasks. In one embodiment, the CPU 105 has a driver that communicates with, controls, or manages the ASC 110. The CPU 105 may be a general-purpose processor, a digital signal processor, a microcontroller, or a specially designed processor such as one design from Application-Specific Integrated Circuit (ASIC). It may include a single core or multiple cores. Each core may have multi-way multi-threading. The CPU 105 may have simultaneous multithreading feature to further exploit the parallelism due to multiple threads across the multiple cores. In addition, the CPU 105 may have internal caches at multiple levels. The CPU 105 communicates with other devices in the system via a bus 114. The bus 114 may be any suitable bus connecting the CPU 105 to other devices. For example, the bus 114 may be a Direct Media Interface (DMI). The bus 114 may also include other custom buses such as bus for the interface to the analog section when the system 100 is used as a mobile device.

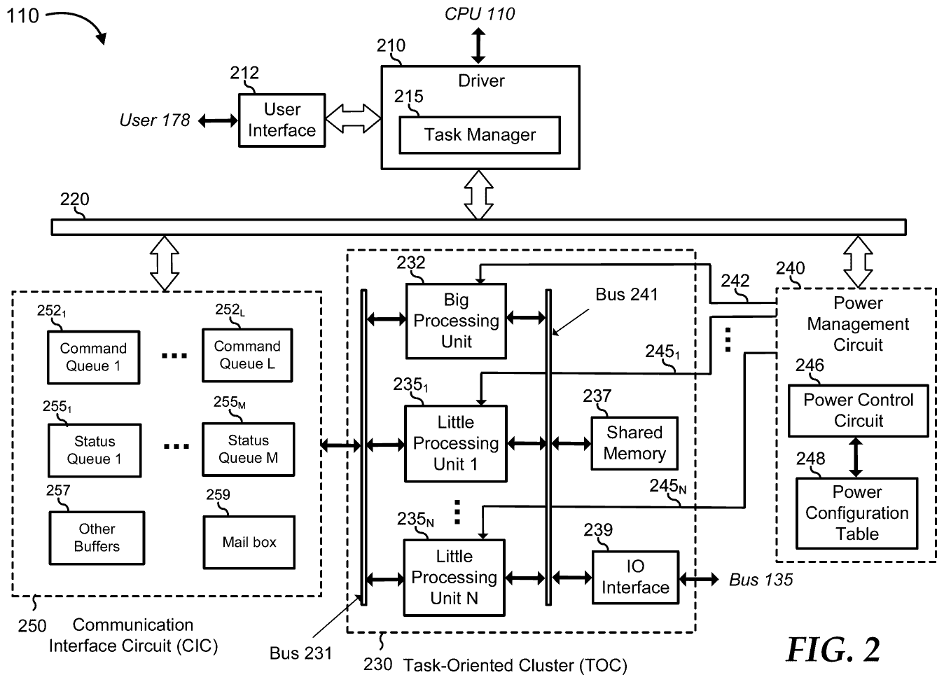

The ASC 110 is a cluster of processing units or elements to enhance the performance of the CPU 105 within a certain power budget. It may replace processing units that have specialized functions such as a graphics processing unit (GPU), a neural processing unit (NPU), a machine learning unit, a image processing unit, a signal processing unit, or other units designed to perform special functions with high throughput and low power. The ASC 110 enhances performance by using multiple processors with adjustable capabilities based on operational and power requirements. The workload may be distributed among the processors or units according to the task. The number of processing elements in the ASC 110 is not fixed and may be any suitable number according to computational and/or power requirements. The ASC 110 will be described further in FIG. 2.

The RF and analog baseband interface circuit 112 provides an interface to the RF transceiver circuit 160, and the analog baseband circuit 190. It may include digital buffers to buffer digital data, operations amplifiers to buffer or amplify analog signals, analog and/or digital multiplexers to steer signals or data to proper channels.

The memory controller 120 controls memory devices such as a main memory 122, a cache memory 124, and a flash memory 126. The main memory 122 includes random access memory (RAM) including static RAM (SRAM) and dynamic RAM (DRAM) and/or the read-only memory (ROM) and other types of memory. The DRAM may include Synchronous DRAM (SDRAM), Double Data Rate SDRAM (DDR SDRAM) with variations (e.g., DDR2, DDR3, DDR4, DDR5, and DDR6). The main memory 122 may store instructions or programs, loaded from a mass storage device, that, when executed by the CPU 105, cause the CPU 105 to perform operations as described in the following. It may also store data used in the operations. The ROM may be a solid-state drive (SSD) and include instructions, programs, constants, or data that are maintained whether it is powered or not. The instructions or programs may correspond to the functionalities described in the following.

The I/O controller 130 controls input devices 140, output devices 150, and mass storage 158. The input devices 140 may include a keyboard 143, a mouse 144, an image sensor or camera 145, a game console 146, and a microphone 147. Other input devices (not shown) may also be available such as stylus, joystick, scanner, and light pen. The output devices 150 may include a printer 152, a monitor or screen 153, a headset 154, and a multi-monitor set 155. When used as a computing device without mobile features, the monitor 153 is a high resolution display. For games and other multi-display mode, the multi-monitor set 155 provides high-resolution with multiple monitors (e.g., three monitors). When used for mobile communication, the screen 153 provide the primary interface for the user to navigate, access various applications and perform tasks. The screen 153 may use organic light-emitting diode (OLED) (super retina) display with multi-touch or haptic touch feature. The mass storage 158 may include CD-ROM, hard disk, and SSDs. The I/O controller 130 also has a network interface card (NIC) 135 which provides an interface to a network and wireless medium 137.

Additional devices or bus interfaces may be available for interconnections and/or expansion. Some examples may include the Peripheral Component Interconnect Express (PCIe) bus, the Universal Serial Bus (USB), etc.

The transceiver circuit 160 includes a transmitter 162, an antenna array 180, a voltage-controlled oscillator (VCO) 161, and a receiver 172. The RF circuit 160 operates at a high GHz frequency band to accommodate modern cellular equipment such as the wireless fifth generation (5G).

The transmitter 162 transmits the digital baseband data to the antenna array 180. The transmitter 162 may include a digital-to-analog converter (DAC) 163, an automatic gain controller (AGC) 164, an intermediate frequency (IF) circuit 165, a mixer 166, an RF circuit 167, and a power amplifier (PA) 168. Other components that are not shown may include filters, amplifiers, multiplexers, coaxial cables, phase shifters, etc. The DAC 163 converts digital data f₁ into an analog signal f₂. The AGC 164 automatically adjusts the signal amplitude of f₂ to generate a signal f₃ to maintain a consistent strength level in a dynamic and changing environment. The IF circuit 165 performs intermediate frequency processes such as filtering to generate a signal f₄. The mixer 166 converts the frequency of the signal f₄ to another frequency. This is done by mixing the signal f₄ with a signal vₜ from the VCO 161. Mixing here refers to frequency modulation which translates the signal f₄ to a signal f₅ at a different frequency. For transmitter, the translated frequency is higher than the frequency of f₄. The conversion is called up-conversion. For 5G communication, the frequency range may include low-band (below 1 GHz), mid-band (1 GHz to 6 GHz), and high-band (24 GHz to 53 GHz or higher). The resulting signal f₅ then goes through various radio frequency processes performed by the RF circuit 167 such as high-pass filtering to produce a signal f₆. The signal f₆ is strengthened and amplified by the PA 168 to produce a signal f₇. The signal f₇ then goes to the antenna array 180 to be transmitted to an appropriate destination and medium (e.g., base station). The antenna array 180 uses beam forming to focus radio waves from f₇ in a desired direction. The antenna array 180 may be used for both transmitting and receiving. On receiving, the antenna array 180 receives an RF signal and sends it to the receiver 172. The number of antennas in the antenna array 180 depends on the desired coverage. The antenna array 180 may include antennas 181, 182, 183, and 184 configured to operate with 5G communication, Gigabit Long Term Evolution (LTE), Wi-Fi (e.g., 2.4 GHz, 5 GHz, and 6 Ghz), and Bluetooth, respectively. The number of antennas may be more or less than the above.

The VCO 161 couples multiple in-phase oscillators together to provide low phase noise oscillation. It generates signals vₜ and vᵣ to the mixers 166 and 175, respectively, at specified frequencies. It may include multiple oscillation core circuits (or VCO cores) to provide high-frequency periodic signals.

The receiver 172 processes the received signal r₇ in a manner reverse from the transmitter 162. It may include a low noise amplifier (LNA) 173, an RF circuit 174, a mixer 175, an IF circuit 176, an AGC 177, and an analog-to-digital converter (ADC) 178. The receiver 172 may include more or less than the above components. The LNA 173 amplifies the weak signal r₇ while maintaining a good signal-to-noise ratio (SNR) to produce a signal r₆ for further processing. The signal r₆ is next processed by the RF circuit 174 such as band-pass filtering to provide a signal r₅. Additional filtering may be performed in the next stages. The signal r₅ is then mixed with the signal vᵣ from the VCO 161 to down convert the signal r₅ to a signal r₄ at an appropriate low frequency. Like the mixer 166 but with a reverse operation, the mixer 175 performs frequency modulation to translate the high frequency signal r₅ to a low frequency signal r₄. The signal r₄ goes through IF processing such as additional filtering by the IF circuit 176 to produce a signal r₃. The AGC 177 amplifies and strengthens the signal and generates a signal r₂. The ADC 178 converts the analog signal r₂ into digital data r₁ which will be processed by the CPU 105 or the ASC 110.

The analog baseband circuit 190 provides analog processing for various components. It may include a baseband unit 192, audio device circuit 193, sensor circuit 194, SIM card 195, and power supply/battery 198. The analog baseband circuit 190 may include more or less than the above components.

The baseband unit 192 handles processing of signals and data between the digital baseband circuit and the RF transceiver circuit 160. It may include analog and digital components to perform various tasks including modulation/demodulation, controlling the RF transceiver circuit 160, special circuitry for 3G, 4G/LTE, Bluetooth, and 5G communication. It may also interface with an audio device circuit 193, a sensor circuit 194, a Subscriber Identity Module (SIM) card 195, and other components. The audio device circuit 193 may include operational blocks to process audio signals and perform audio-related functions such as filtering, correlation, speech recognition. It may include digital circuits to perform Fast Fourier Transform (FFT) to perform signal processing in the frequency domain. The sensor circuit 194 may include a variety of sensors such as proximity, ambient light, motion (accelerometer and gyroscope, compass, barometer, fingerprint sensor for touch identification (ID), image sensors for face ID, light detection and ranging (LiDAR) scanner, etc. The SIM card 195 is a small, removable chip that stores the user's phone number and carrier information, allowing the device to connect to a cellular network.

The power supply and battery circuit 198 provides power and battery backup supply to the entire system. It may include a charger to charge the battery. The battery may be a rechargeable battery, of Lithium-Ion battery. Power management may be performed by application software and circuits to provide low power mode and performance management.

The system 100 is an example that illustrates the role of the ASC in high computing (HC) and specialized platforms, especially graphics in a mobile environment. In many cases, the environment of the applications adds additional requirements including low power consumption, reliable signal integrity, fault-tolerance, and reliable operations in extreme conditions including heat and tight space. Examples of other applications that would benefit from a cluster of processing elements with specialized design include mobile communication (e.g., smart phones, base stations, user equipment), cameras, vehicles, entertainment (e.g., games, multimedia, music, movies), technical designs (e.g., animation, graphics), medical (e.g., visualization, medical imaging), robotics, drones, automatic test equipment, audio processing, speech synthesizer, video and image analysis, vision, automatic face recognition, artificial intelligence (AI) applications, and data centers.

FIG. 2 is a diagram illustrating the ASC 110 shown in FIG. 1 according to an embodiment. The ASC 110 includes a driver 210, a task-oriented cluster (TOC) 230, a power management circuit 240, and a communication interface circuit (CIC) 250. The ASC 110 may include more or less than the above components.

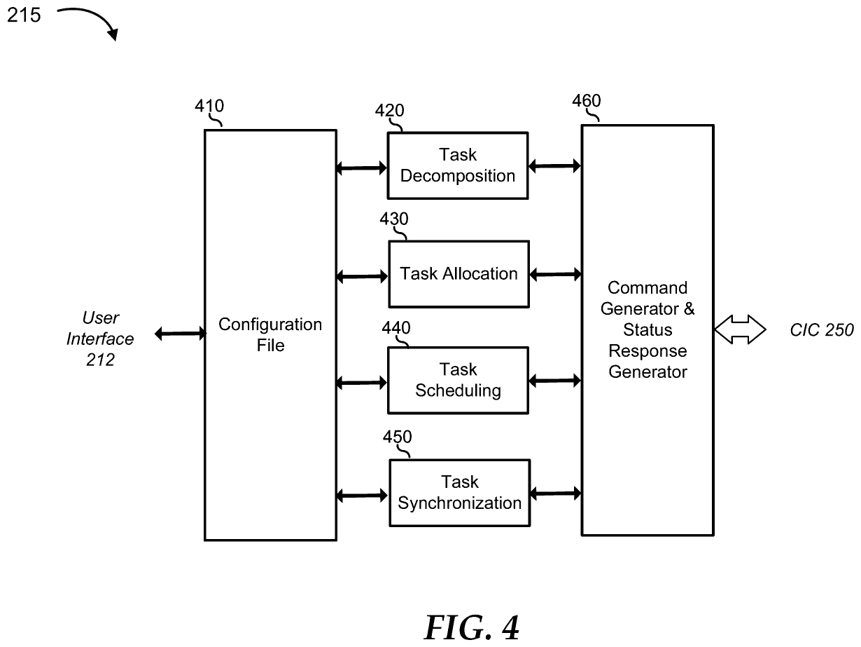

The driver 210 is an application executed by the CPU 110. It may perform various control or management functions. In particular, it has a task manager 215 that manages the tasks to be assigned to the processing units in the TOC 230. The driver 210 has a user interface 212 to communicate or interact with the user 148 (shown in FIG. 1). The user 148 may configure the task and the criteria such as processing time and power budget. The task manager 215 may optimize the performance of the task by decomposing the task into sub-tasks and assigning the sub-tasks to the processing units in the TOC 230. The task manager 215 will be described further in FIG. 4. The driver 210 interfaces with the TOC 230, the power management circuit 240 and the CIC 250 via bus 220. The bus 220 may be a physical bus or a “software bus” that allows the driver 210 to communicate with other applications or devices. The communication medium may be any suitable medium such as universal serial bus (USB) or Windows Driver Model (WDM).

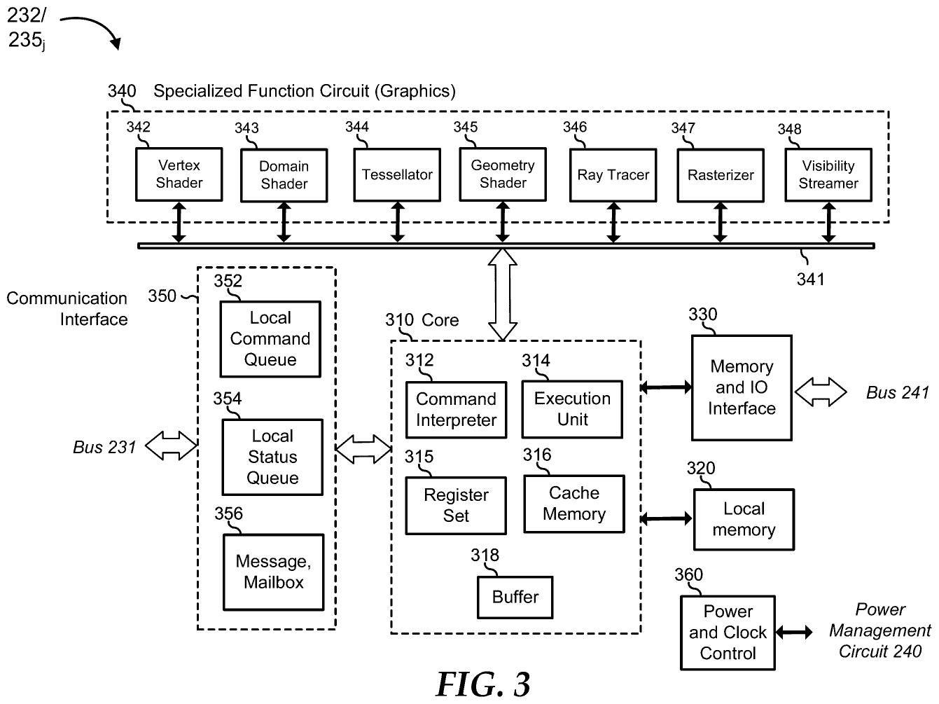

The TOC 230 is the core computing unit for the ASC 110. It is configured to perform the specialized functions required for the task. It may contain a common set of operations that are common to many of the functionalities. For example, matrix multiplication is a basic computation in several tasks in graphics, image analysis, video processing, machine learning model, neural networks, and signal processing. It includes a big processing unit (BPU) 232 and N Little Processing Unit (LPU) 235₁ to 235_{N} where N is a positive integer. The term processing unit (PU) can be used to refer to either the BPU 232 or the LPU 235ⱼ's (j=1, . . . , N) or both. In one embodiment, the BPU 232 is designed with an architecture having full functionality including computing elements, memory, and IO interfaces, and the LPUs are designed with partial architecture with partial functionality compared to the BPU 232 with less power such as fewer computing elements or smaller memory sizes. In other embodiments, the BPU 232 and the LPUs 235ⱼ's (j=1, . . . , N) are identical, or only slightly different in terms of interfacing to other devices. In alternative embodiments, all the BPU 232 and the LPU's 252ⱼ's are identical with the same architecture but with adjustable or reconfigurable power or capability. For example, they may have identical computing and resource elements, but these elements may be enabled or disabled depending on the system configuration for a particular task. By disabling certain computing and/or resource elements in a PU, power saving may be achieved. The reconfigurability of the PU's provides flexibility, programmability, and adaptivity for a variety of computing tasks and requirements. The BPU 232 and the LPUs 235ⱼ's receive control signals from the power management circuit 240 to configure the power and/or operational mode such as power down, low power, enable, and disable. The BPU 232 and the LPUs 235ⱼ's will be described further in FIG. 3.

The BPU 232 and the LPUs 235ⱼ's are connected to bus 231 and bus 241. The two buses may be separate or the same. To avoid bus contention, they are separated. Bus 231 is dedicated for intercommunication and bus 241 is dedicated to resource sharding including a shared memory 237 and an IO interface 239. Each of the BPU 232 and the LPUs 235ⱼ's is an independent processor or processing element. Each has its own execution unit and memory and can execute its own program. The bus 231 provides a means for them to exchange information, inquiring status, and/or sending instructions or commands. The bus 231 is interfaced to the CIC 250 to allow the BPU 232 and the LPUs 235ⱼ's to communicated with the driver 210 or the CPU 110. The bus 241 allows the BPU 232 and the LPUs 235ⱼ's to access shared resources including the shared memory 237 and the IO interface 239. The shared memory 237 may be any suitable memory including SRAM, DRAM, or SSD. The objective is to allow the BPU 232 and the LPUs 235ⱼ's to pass intermediate results or data when they cooperate in working on a task. For example, suppose the BPU 232 and the LPU 235₁ are assigned sub-task 1 and sub-task 2, respectively, in a pipeline. Suppose sub-task 2 needs the result of sub-task 1. The BPU 232 retrieves the initial data from the shared memory 237, processes the data, and returns the result back to the shared memory 237. Thereafter, the BPU 232 sends a status to the LPU 235₁, via the bus 231, to inform that the result is now available in the shared memory 237. The LPU 235₁, upon receiving the status, will access the shared memory 237 and perform the sub-task 2. The shared memory 237 may have any suitable organization. For example, it may be double-buffered so that while one buffer is available to reading, another buffer is available for writing, and the mode can be switched to alternate the role. The IO interface 239 provides any one of the PU's to access IO devices at bus 135 (FIG. 1) for example. Alternatively, the IO interface 239 may allow accesses to IO devices local to any one of the PU's.

The power management circuit 240 provides control and management of power for the BPU 232 and the LPU's 235₁ to 235_{N} through the control signal lines 242 and 245₁ to 245_{N}, respectively. It may also receive the power status of the BPU 232 and the LPU's 235₁ to 235_{N} via the signal lines 242 and 245₁ to 245_{N}. The power management circuit 240 may receive instructions to send control signals from the task manager 215 via the CIC 250 based on a power policy determined by the task manager. The policy may be obtained from the criteria or performance requirements. The power management circuit 240 may access the mail box 259 in the CIC 250, receive the instructions directly on the bus 230, or configure the control by itself. It has a power configuration table 245 that is created to provide power scheduling or mode for a task as assigned by the task manager 215. The task manager 215 typically knows in advance what sub-task is assigned to which PU and what sub-task would consume what kind of power and therefore it can establish the power configuration table 245 in advance. The power control circuit 242 can send out control signals according to the power configuration table 245. The configuration of power supplied to the BPU 232 and the LPU's 235₁ to 235_{N} may be performed by any suitable means such as global control or local control. For example, suppose the power management policy is to disable a PU after it finishes a sub-task, then when a PU, say LPU 235₃, finishes its sub-task, it sends its completions status to the power management circuit 240 via the signal/status line 245₃. The power management circuit 240, upon receiving the completion status on the signal/status line 245₃, it will issue a disable control line on the signal/status line 245₃ to disable the LPU 235₃ or a component of the LPU 235₃.

The power mode to each of the BPU 232 and the LPU's 235ⱼ's may be controlled in a number of ways. For example, the power lines may be gated by an appropriate logic circuit so that the line may be turned off when activated. Alternatively, the power mode may be controlled by controlling the clock frequency. Slowing the clock typically reduces power consumption. This may be accomplished by switching the clock source, or changing the counter for the divide-by-N circuit in the clock generator.

The CIC 250 is a communication interface configured to provide the driver 210, the BPU 232 and the LPU 235ⱼ's with an interface to communicate with one another. The CIC 250 includes command queue 252ⱼ's (j=1, . . . , L), status queue 255ⱼ's (j=1, . . . , M), other buffers 257, and mail box 259. L and M are two positive integers and they may be the same or different. They may also be the same or different from N. In a typical scenario, L=M=N+1. In other words, each PU is assigned a command queue and a status queue. For example, suppose N=3. Therefore, there are a BPU 232 and three LPUs for a total of 4 PU's. There will be four command queues and four status queues. Command queues 252₁, 252₂, 252₃ will be assigned to LPU 235₁, LPU 235₂, and LPU 235₃, respectively. Command queue 252₄ will be assigned to BPU 232. The status queues 255ⱼ's will be assigned in a similar manner. The command queues 252ⱼ's include a series of commands to the corresponding PU's. The commands may include instructions for the corresponding to perform a sub-task. Depending on the format of the command, the command may include conditional instructions which specify the operations to be performed if a certain condition is met. In some embodiments, a PU may be configured to access the command queue of another PU so that it can perform as a Command Processor to interpret the commands without performing any of the tasks. For example, suppose there are two PU;s: the BPU 232 and the LPU 235. The BPU 232 may be assigned to perform graphic rendition task while the LPU may be assigned to access the command queues for the BPU and act as a Command Processor to interpret the commands and communicate the result to the BPU 232 through their local queues, mailboxes or shared memory.

The status queues 255j's store status information as reported by the associated PU's. The status information may be any status that is useful for the task. For example, it may be a DONE status which indicates a sub-task or a command in a sub-task has been completed. It may also be an ERROR status which indicates an occurrence of an error or failure during the performance of the sub-task. It may be a PENDING status which indicates a condition where the associated PU is waiting for a status of another event.

The other buffers 257 provide additional storage for transferring data or instructions to the BPU 232 and LPU 235j's. For example, suppose the sub-task is to perform a non-recursive filtering on a set of data having a length of P. The P filter coefficients may be stored in the other buffers 257. The mailbox 259 provides a means to exchange messages other than commands and statuses. For example, it may store power management instructions or status.

In general, the CIC 250 allows the driver 210 to communicate with the BPU 232 and the LPU 235ⱼ's. The BPU 232 and the LPU 235ⱼ's may also use the CIC 250 to communicate with one another. Through the CIC 250, the BPU 232 and the LPU 235ⱼ's can execute programs or instructions seamlessly without constant exchanges of information with the driver 210.

The allocation of tasks and assignment of tasks to the PU's may be flexible to allow various configurations depending on task requirements and criteria. In some embodiments, the BPU 232 may be assigned to perform main tasks and one or more LPU's 235ⱼ's may be assigned to perform other tasks such as command processing or special functions (e.g., neural network accelerator).

FIG. 3 is a diagram illustrating the big/little processing unit 232/235ⱼ according to an embodiment. The big/little processing unit 232/ 235ⱼ is configured to perform specialized functions such as graphics, image analysis, machine learning, neural networks, and signal processing. It may have specialized hardware structure to carry out fast computations. FIG. 3 illustrates an embodiment with a graphics function but other embodiments may use other functions as appropriate. The big/little processing unit 232/235ⱼ includes a core 310, a local memory 320, and memory and IO interface 330, a specialized function circuit 340, a communication interface 350, and a power and clock control 360. The big/little processing unit 232/235ⱼ may include more or less than the above components.

The core 310 is the execution engine of the PU. It includes a command interpreter 312, an execution unit 314, a register set 315, a cache memory 316, and a buffer 318. The core 130 may operate in two modes. In the first mode, it executes instructions or commands as sent from the task manager 215. In the second mode, the command from the task manager 215 points to the code that performs the command in the local memory 320. In other words, in the second mode, the command from the task manger 215 acts like a calling function that invokes the routine or program code corresponding to the command. The command interpreter 312 is similar to an instruction decoder in a CPU. It interprets or decodes the command received from the communication interface 350 which obtains the commands from the CIC 250 (FIG. 2). The decoded command is then passed to the execution unit 314 for execution. The register set 315 provides a set of registers that store the data to be operated on. The cache memory 316 provides fast access to the memory which may contain instructions or data for the sub-task. The buffer 318 may contain an additional storage or is organized as a first-in-first-out (FIFO) for special access mode.

The local memory 320 stores instructions or data in a code corresponding to the command being executed. It may be any suitable memory type such as SRAM, DRAM, or SSD. It may contain a program to be executed when the core 310 decodes the command and operates in the second mode. The memory and IO interface 330 provides interface to the bus 241 to allow access to the shared memory 237 or the IO interface 239 (FIG. 2).

The specialized function circuit 340 implements the specified function such as graphics, image analysis, machine learning, neural networks, or signal processing. It interfaces with the core 310 via a bus 341. In some embodiments, the specialized function circuit 340 is different among the PU's. For example, one PU (e.g., the BPU 232) may have the specialized function circuit 340 with graphics processing elements or modules while another PU (e.g., the LPU 235) may have the specialized function circuit 340 with neural network accelerator. In some embodiments, the specified function is common among the PU's such as graphics. As an example, for graphics function, the specialized function circuit 340 includes a vertex shader 342, a domain shader 343, a tessellator 344, a geometry shader 345, a ray tracer 346, a rasterizer 347, and a visibility streamer 348. The specialized function circuit 340 may include more or less than the above elements or modules. Any one of these elements or modules may be implemented by a hardware circuit, a set of commands or instructions, or a combination of a hardware circuit and commands. When a function is implemented by a hardware circuit, the core 310 will interact with the function including enabling or disabling the function. When a function is implemented by a set of commands, the core 310 will execute the function by fetching the function commands via the bus 341 and executing the command as usual. In alternative embodiments, these functions may be implemented by a set of instructions stored in the local memory 320 which may be a non-volatile memory and the core 310 will execute these instructions as a normal code execution.

The above functions or modules are typical graphics functions. For example, the vertex shader 342 processes vertices including performing transformations, skinning, and lighting. The domain shader 343 calculates the vertex position of a subdivided point in the output patch. The ray tracer 346 traces the path of light from the view camera, through the 2D viewing plane, out into the 3D scene, and back to the light sources. The rasterizer 347 creates objects from a mesh of virtual triangles, or polygons, that create 3D models of objects. It may also convert a vector-based image or object into a raster or bitmap format. The visibility streamer 348 determines the primitives which are potentially visible from a viewpoint.

The communication interface 350 provides another level of communication in addition to the CIC 250. It includes a local command queue 352, a local status queue 354 and a message or mailbox 356. The local command queue 352 stores commands that may be pre-fetched from the associated command queue 252ⱼ in the CIC 250 (FIG. 2). Prefetching speeds up the processing time and avoids contention at the bus. Similarly, the local status queue 354 allows pre-fetching to transfer the data to the associated status queue 255j in the CIC 250 (FIG. 2). The message and mailbox 356 provides an additional storage or buffer for messages other than command or status.

The power and clock control 360 interfaces with the power management circuit 240 via the signal/status lines 242 and 245₁ to 245_{N}. It may include logic circuits such gating and/or counter circuits to enable/disable the PU's or change the clock frequency.

FIG. 4 is a diagram illustrating the task manager 215 in FIG. 2 according to an embodiment. The task manager 215 manages the PU's to perform the assigned task with enhanced performance and low power consumption. It includes a configuration file 410, a task decomposition 420, a task allocation 430, a task scheduling 330, a task synchronization 450, and a command generator and status response (CGSR) generator 460. The task manager 215 may include more or less than the above components.

The configuration file 410 stores the configuration of the task. The configuration of the task describes the environment, the available resources, the size of the task, the task criteria including the processing time and the power budget. The configuration file 410 is typically created by the user 178 through the user interface 212.

The task decomposition 420 decomposes the task by dividing the task into sub-tasks based on the available resources. The objective is to divide a large, complex task into smaller, manageable sub-tasks. The task decomposition may analyze the dependencies among the sub-tasks and the relationship between the sub-tasks. For example, suppose the available PU's is 8 with one BPU and 7 LPU's. The task decomposition 420 may decide the divide the animation task into 32 sub-tasks. The task allocation 430 allocates the sub-tasks to the PU's and allocates the memory accordingly. For example, based on the dependencies analysis, the task allocation 430 allocates the BPU to process sub-task 2, the LPU1 to process sub-task 7 and 13, etc. The task scheduling 440 schedules the task for execution according to some pre-defined order based on the analyzed dependencies. For example, the task scheduling 440 schedules the BPU, the LPU1, and LPU6 to start at the same time; the LPU4 starts as soon as LPU1 is finished, etc. Dependencies may also be managed using asynchronous communication such as message passing (e.g., mailbox 259 or 356) or shared memory (e.g. the shared memory 237). The task synchronization 450 ensures that tasks are synchronized among themselves and/or from frame to frame. For example, if LPU5 finishes its sub-task before LPU3 and it is required that the results of LPU5 and LPU3 should be available at the same time, the task synchronization 450 may hold LPU5 in wait until LPU3 finishes its sub-task.

The CGSR generator 460 translates the results of the task decomposition 420, the task allocation 430, the task scheduling 440, and the task synchronization 450 into commands that can be issued to the PU's. In addition, it also determines what action to take upon receiving a status from a PU. For example, if LPU3 reports a PENDING status while executing sub-task, then a command to inquire the status of LPU4 should be executed. After the CGSR generator 460 generates all the commands, it will transfer the commands to the appropriate command queues 252ⱼ's (j=1, . . . , L).

The application-specific cluster (ASC) 110 is configured for fast processing time having at least two processing units. It is also flexible to be configured for any combination of processing units and resources. The BPU 232 may be the main processing unit. In some embodiments, one or more LPU's 235ⱼ's may be turned off or disabled depending on power budget. When one or more LPU's 235ⱼ's are enabled and work together with the BPU 232, the workload may be distributed based on some workload distribution algorithm from the task manager 215 as discussed in FIG. 4. In some embodiments, the PU's may be configured to work in parallel or concurrently. This operating mode is especially relevant for pipeline operations. In a typical pipeline mode, more than one PU's may execute commands or instructions simultaneously on different sub-tasks. There are two basic types of parallelism: temporal parallelism and spatial parallelism. When dependencies can be resolved after some delay time, the sub-tasks may be overlapped and executed concurrently.

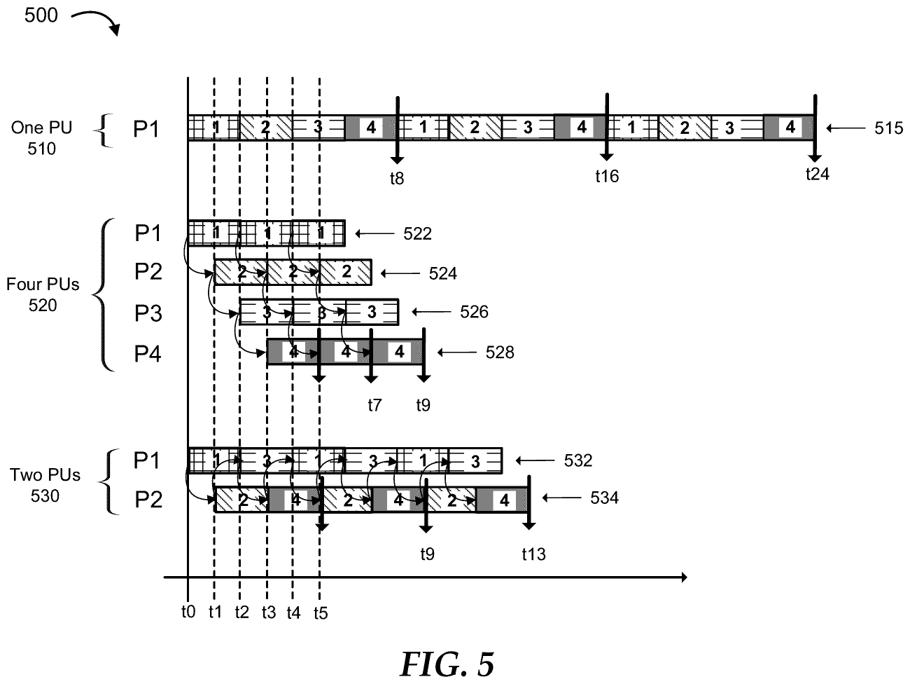

FIG. 5 is a diagram illustrating an execution 500 of a pipeline for temporal parallelism according to an embodiment. The execution 500 includes three cases: One PU case 510, Four PU's case 520, and two PU's case 530. The horizontal axis refers to the time axis with values t0, t1, t2, . . . , t24.

In the first case of 510, one processing unit P1 is used for a pipeline 515. The pipeline has 4 stages: 1, 2, 3, and 4. For simplicity, suppose each stage needs two time units. Suppose the entire task has three processing periods, each period takes 4 stages. Since there is only one PU, no parallelism is possible. Therefore, the entire tasks will be completed in 24 time units, at t24.

In the second case of 520, four PU's are used: P1, P2, P3, and P4. The pipeline 515 is decomposed into four overlapping pipelines 522, 524, 526, and 528 assigned to P1, P2, P3, and P4, respectively. The four stages 1, 2, 3, and 4 are assigned to the four pipelines 522, 524, 526, and 528. Suppose the dependency is resolved after half of a period of a preceding stage is completed. In other words, stage 2 in pipeline 524 can start in the middle of stage 1 of pipeline 522. Similarly, the second stage 3 of pipeline 526 can start in the middle of the second stage 2 in pipeline 524. By overlapping the stages and assigning the group of the same stages to a PU, the processing time is greatly improved. As illustrated, the entire task is completed in 9 time units, at t9.

In the third case of 530, two PU's are used: P1 and P2. The pipeline 515 is decomposed into two pipelines 532 and 534 assigned to P1 and P2, respectively. The pipeline 532 includes three groups of stages 1 and 2. The pipeline 534 includes three groups of stages 2 and 4. As in case 520, suppose the dependency is resolved after half of a period of a preceding stage is completed. As illustrated in FIG. 5, the first stage 3 of pipeline 532 can start in the middle of the first stage 2 in pipeline 534. The entire task is completed in 13 time units, at t13.

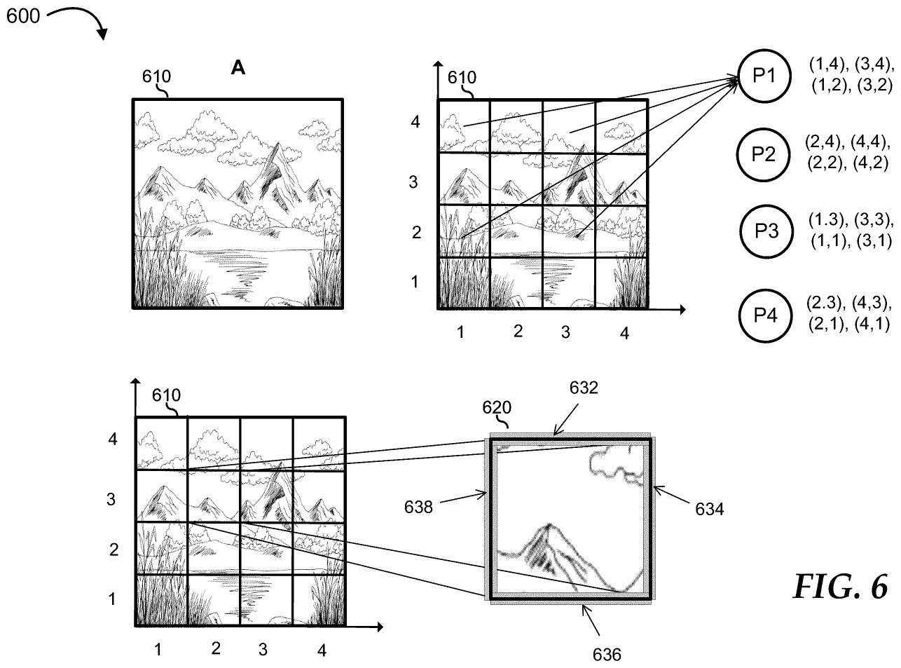

FIG. 6 is a diagram illustrating an execution 600 of a pipeline for spatial parallelism according to an embodiment. The execution 600 includes a graphic rendition of an image A in frame 610. Suppose the frame 610 is decomposed into 4×4 blocks. Each block is identified by the horizontal and vertical axes as 1, 2, 3, and 4. As an example, block (1,4) corresponds to the upper left block, block (4,4) corresponds to the upper right block. Suppose four PU's are used. Since there are 16 blocks and 4 PU's, one PU will be assigned to work on four blocks. For example, P1 is assigned to work on blocks (1,4), (3.4), (1,2), and (3,2); P2 is assigned to work on blocks (2,4), (4,4), (2,2), and (4,2); P3 is assigned to work on blocks (1,3), (3,3), (1,1), and (3,1); and P4 is assigned to work on blocks (2,3), (4,3), (2,1), and (4,1).

For image analysis, operations such as edge detection can operate in blocks because these operations only involve local masks (e.g., 3×3) and these operations can be done in parallel. For some graphics operations, there may be initial conditions at the boundaries at each block. For example, block (2,4) representing an image 620 has four boundaries 632, 634, 636, and 638. To maintain continuity at these boundaries, the graphic operations on block (2,4) may need to know information at these boundaries to complete its operation. For many graphics tasks, this may not present a problem because the primitives of the entire graphic image are typically calculated first before the graphic rendering. In addition, several graphics operations may be performed in parallel. Some examples are drawing pixels, transforming vertices, clipping and geometry shaders, etc.

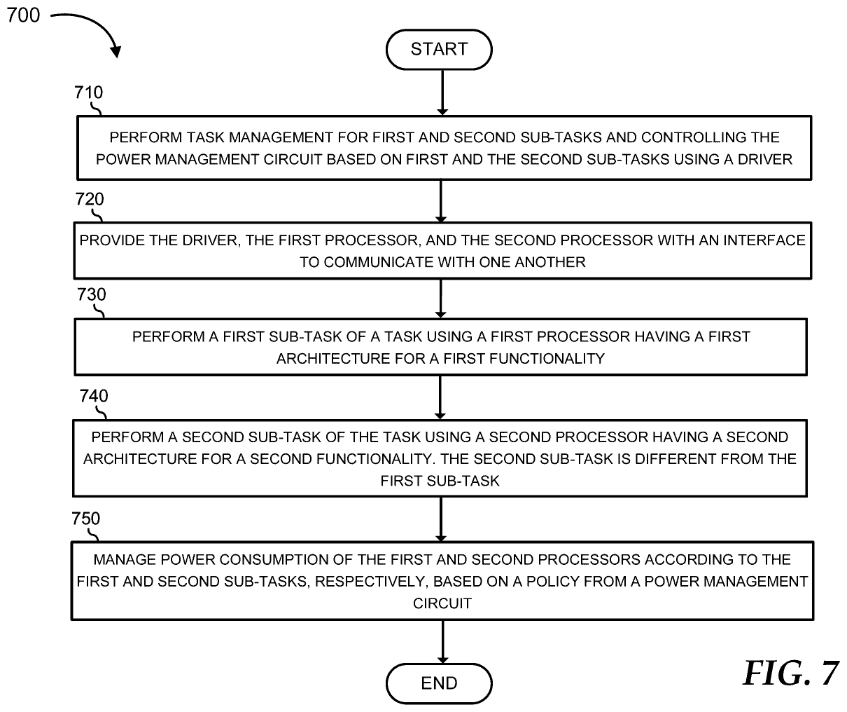

FIG. 7 is a flowchart illustrating a process 700 for performing a task in a cluster of processing units according to an embodiment. The process 700 operates according to the illustrations shown in FIGS. 2 and 3.

Upon START, the process 700 performs task management for a first sub-task and a second sub-task of a task and controls a power management circuit based on the first and the second sub-tasks using a driver (Block 710). In a graphic application, the task may be rendition of a 3D object. The sub-tasks may be vertex shader, domain shader, etc. Next, the process 700 provides the driver, a first processor, and a second processor with an interface to communicate with one another (Block 720). The communication involves the driver sending commands to the command queues and reads status information from the status queues.

Then, the process 700 performs the first sub-task of the task using a first processor having a first architecture for a first functionality (Block 730). The first processor may be any one of the BPU 232 or the LPU's 235ⱼ's. The first architecture may include the elements shown in FIG. 3. The first functionality may refer to one sub-task. Next, the process 700 performs the second sub-task of the task using a second processor having a second architecture for a second functionality (Block 740). The second processor may be any processing unit that is different from the first processor. For example, if the first processor is the BPU 232, then the second processor may be the LPU 235₁. The second sub-task is different from the first sub-task. For example, if the first sub-task is vertex shader, then the second sub-task may be domain shader.

Then, the process 700 manages power consumption of the first and second processors according to the first and second sub-tasks, respectively, based on a policy from a power management circuit (Block 750);. The policy may be determined by the task manager in the driver according to the performance criteria or requirements. The process 700 is then terminated.

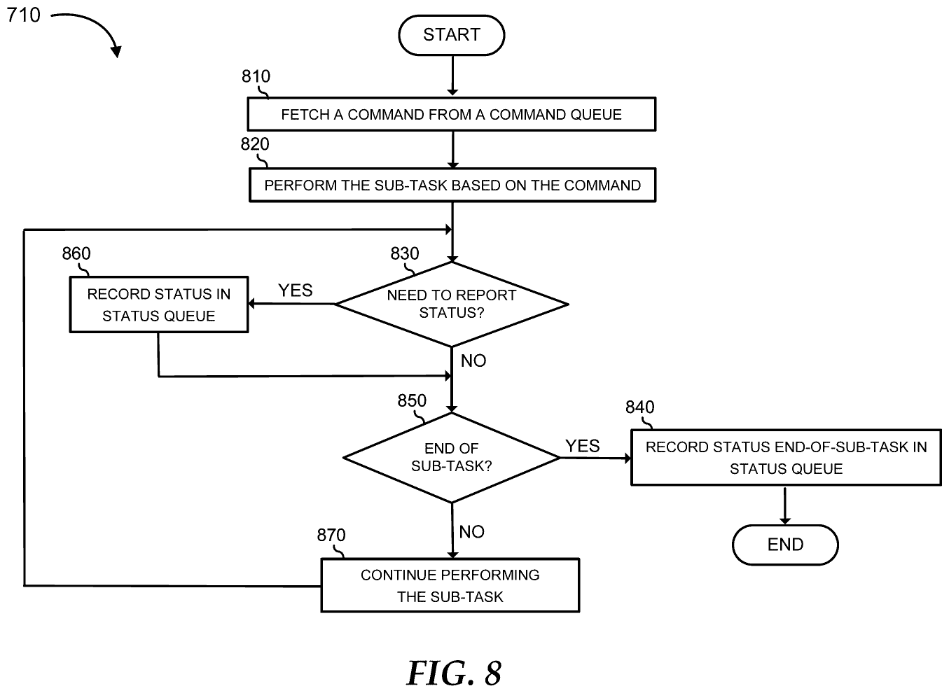

FIG. 8 is a flowchart illustrating the process 730/740 for performing a sub-task using a processor in a cluster of processing units according to an embodiment.

Upon START, the process 730/740 fetches a command from a command queue (Block 810). The command queue is the queue corresponds to the processor. Thus, if the processor is the first processor, the command queue is the first command queue. Similarly, if the processor is the second processor, the command queue is the second command queue. Next, the process 730/740 performs the sub-task based on the command (Block 820). The sub-task corresponds to the assigned processor. Then, the process 730/740 determines if there is a need to report the status of the operation of the sub-task (Block 830). This may be triggered by an event during the execution of the sub-task. If so (YES at block 830), the process 730/740 records the status in the corresponding status queue (Block 860). For example, if there is an error, the process 730/740 will record an ERROR status in the status queue. The process 730/740 then proceeds to Block 850. If there is no event that triggers status recording (NO at block 830), the process 730/740 determines if it reaches the end of the sub-task (Block 850). If not (NO at block 850), the process 730/740 continues performing the sub-task (Block 870) and returns to block 830. Otherwise (YES at block 850), the process 730/740 records the status END-OF-SUB-TASK in the corresponding status queue (Block 840) and is then terminated.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a first processor having a first architecture for a first functionality and configured to perform a first sub-task of a task;
a second processor having a second architecture for a second functionality and configured to perform a second sub-task of the task, the second sub-task being different from the first sub-task;
a power management circuit configured to manage power consumption of the first and second processors according to the first and second sub-tasks, respectively; and
a driver configured to perform task management for the first and second sub-tasks and control the power management circuit based on the first and the second sub-tasks.

2. The apparatus of claim 1 further comprising:
a communication interface configured to provide the driver, the first processor, and the second processor with an interface to communicate with one another.

3. The apparatus of claim 2 wherein the communication interface includes a first command queue and a first status queue associated with the first processor and a second command queue and a second status queue associated with the second processor.

4. The apparatus of claim 3 wherein the driver sends a command to at least one of the first command queue or the second command queue and reads a status from at least one of the first status queue or the second status queue.

5. The apparatus of claim 4 wherein the second processor is configured to read a first status in the first status queue of the first processor and the first processor is configured to read a second status in the second status queue of the second processor.

6. The apparatus of claim 1 wherein the task management includes at least one of task decomposition, task allocation, task scheduling, or task synchronization.

7. The apparatus of claim 1 wherein a part of the first sub-task and a part of the second sub-task are executed in parallel.

8. The apparatus of claim 1 wherein at least one of the first sub-task or the second sub-tasks is a stage in a pipeline.

9. The apparatus of claim 1 wherein the first processor and the second processor share a common memory.

10. The apparatus of claim 1 wherein the first functionality and the second functionality overlap with each other.

11. A method comprising:
performing a first sub-task of a task using a first processor having a first architecture for a first functionality;
performing a second sub-task of the task using a second processor having a second architecture for a second functionality, the second sub-task being different from the first sub-task;
managing power consumption of the first and second processors according to the first and second sub-tasks, respectively, based on a policy from a power management circuit; and
performing task management for the first and second sub-tasks and controlling the power management circuit based on the first and the second sub-tasks using a driver.

12. The method of claim 11 further comprising:
providing the driver, the first processor, and the second processor with an interface to communicate with one another.

13. The method of claim 12 wherein the communication interface includes a first command queue and a first status queue associated with the first processor and a second command queue and a second status queue associated with the second processor.

14. The method of claim 13 wherein the driver sends a command to at least one of the first command queue or the second command queue and reads a status from at least one of the first status queue or the second status queue.

15. The method of claim 14,
wherein performing the first sub-task comprises reading a second status in the second status queue of the second processor; and
wherein performing the second sub-task comprises reading a first status in the first status queue of the first processor.

16. The method of claim 11 wherein performing task management comprises performing at least one of task decomposition, task allocation, task scheduling, or task synchronization.

17. The method of claim 11 wherein a part of the first sub-task and a part of the second sub-task are executed in parallel.

18. The method of claim 11 wherein at least one of the first sub-task or the second sub-tasks is a stage in a pipeline.

19. The method of claim 11 wherein the first functionality and the second functionality overlap with each other.

20. A system comprising:
a host processor having a driver; and
an application-specific cluster, comprising:
a first processor having a first architecture for a first functionality and configured to perform a first sub-task of a task;
a second processor having a second architecture for a second functionality and configured to perform a second sub-task of the task, the second sub-task being different from the first sub-task;
a power management circuit configured to manage power consumption of the first and second processors according to the first and second sub-tasks, respectively; and
wherein the driver is configured to perform task management for the first and second sub-tasks and control the power management circuit based on the first and the second sub-tasks, and
wherein the first and second sub-tasks are parts of a task.
